(19) United States
(12) Patent Application Publication
(10) Pub. No.: US 2025/0208598 A1
(43) Pub. Date: Jun. 26, 2025

(54) METHOD FOR CONTROLLING A STEPPING MOTOR AND RELATIVE CONTROL DEVICE

(71) Applicant: GH ENTERPRISE S.R.L., Faenza (RA) (IT)

(72) Inventor: Andrea COLLAMATI, Faenza (RA) (IT)

(21) Appl. No.: 18/843,618

(22) PCT Filed: Mar. 8, 2023
(86) PCT No.: PCT/IB2023/052192

§ 371 Date: Sep. 3, 2024

(30) Foreign Application Priority Data
Mar. 9, 2022 (IT) 102022000004442

(51) Int. Cl. G05B 19/40; B29C 64/393

(52) U.S. Cl. CPC G05B 19/40; B29C 64/393; G05B 2219/41326

(57) ABSTRACT

A method for controlling a stepping motor includes the following steps: receiving a movement function, representing a position of the stepping motor over time; processing the movement function and generating a first reference signal, identifying a finished rotation of the stepping motor, and a second reference signal, identifying the direction of the finished rotation controlled by the first reference signal; sending a first and a second control signal to an integrated control circuit of the stepping motor; compensation of the first reference signal and the second reference signal in such a way as to reduce the extent of the vibrations due to a movement of the stepping motor, for generating the first and the second control signals, respectively.

### TECHNICAL FIELD

This invention relates to a method and a controller for controlling a stepping motor. Moreover, more in detail, the invention relates to a method and a controller for controlling a 3D printer.

### BACKGROUND ART

In the sector of the controls for stepping actuators, it is known that the controller receives a movement function which represents a movement of the stepping motor over time. Starting from the movement function, the controller calculates a first reference signal, commonly known by the term STEP, which identifies a finished rotation of the stepping motor, and calculates a second reference signal, commonly known by the term DIR, identifying a direction of rotation controlled by the first reference signal. Said first and second reference signals are sent to a stepping motor control circuit which, on the basis of the first and second reference signals, controls a stepping motor movement.

These controls have some disadvantages, however, mainly linked with the vibration of the bodies moved with the stepping motor due to the inertia of the bodies themselves. As is known, the vibrations depend on the acceleration of the bodies and on the mass parameters associated with them.

The prior art comprises solutions for compensating these vibrations. These solutions modify the generation of the first and the second reference signals, modifying the movement function. More in detail, algorithms are known which, starting from the movement function, generate a compensated movement function through a compensation algorithm. Examples of known compensation algorithms include Input Shaping®, which is described in patent document EP0433375B1 and which will be briefly incorporated into the description of this invention.

Other prior art solutions are described in patent documents US2017312987A1 and U.S. Pat. No. 5,638,267A. For example, patent document US2017312987A1 illustrates a control system for a 3D printer, in which a microcontroller is interposed between the main controller and the driver of the stepping motor. In fact, the microcontroller appears to be able to intervene on the STEP and DIR signals to recover feedback control errors. However, this system is not very precise because it is subject to the vibrations of the processing head. The same drawbacks are also noted in patent document U.S. Pat. No. 5,638,267A.

However, the prior art solutions are characterised by the need to have calculation powers in the controller which are sufficient to implement the compensation algorithms. For this reason, the resulting controllers have drawbacks in terms of cost of the controller required and in terms of flexibility, because the design of the controller must be performed in advance on the basis of the desire or not to provide for the compensation. Moreover, the prior art compensation technique, which acts on the movement function, does not allow, if necessary, the retrofitting of existing controllers to be performed without a complete replacement of the current controller with a new one with calculating powers suitable for the purpose.

### AIM OF THE INVENTION

The aim of the invention is to provide an method and a controller for controlling a stepping motor which overcome the above-mentioned drawbacks of the prior art.

Said aim is fully achieved by the method and by the controller according to the invention as characterised in the appended claims.

According to an aspect of the invention, a method is provided for controlling a stepping motor.

The method comprises a step for receiving a movement function (movement profile), representing a position of the stepping motor over time.

The method comprises a step for processing the movement function. The method comprises a step of generating a first reference signal, identifying a finished rotation of the stepping motor.

The method comprises a step of generating a second reference signal identifying the direction of finished rotation controlled by the first signal.

The method comprises a step of sending a first control signal to a stepping motor control circuit. The method comprises a step of sending a second control signal to a stepping motor control circuit.

The method comprises a compensation step. During the compensation step, the first reference signal is modified in such a way as to reduce the amount of vibrations due to a movement of the motor, for generating the first control signal. During the compensation step, the second reference signal is modified in such a way as to reduce the amount of vibrations due to a movement of the motor, for generating the second control signal.

The fact of providing the compensation modifying the first and/or the second reference signals makes it possible to obtain various advantages. Firstly, it is possible to integrate a control circuit between any existing controllers and the control circuit, thus being able to perform the compensation even in cases wherein the existing controller does not have sufficient calculation capacity. Secondly, that allows retrofitting to be performed on existing machines. In addition, the method proposed allows very flexible and modular controllers to be made which do not impose a choice of calculation capacity and the relative functions only during production. Lastly, the compensation on the first and second reference signals (that is, on the STEP and DIR signals) allows specific control circuits to be used with low calculation power and, therefore, with reduced costs.

According to an embodiment, the compensation step comprises a step of accessing a current position value; representing the current position of the stepping motor.

The compensation step comprises a step of calculating (updating) an ideal position (current) of the stepping motor, representing a position which the stepping motor should adopt according to the movement function. The updating of the ideal position is performed starting from the first reference signal and from the second reference signal. For example, the updating step is performed adding the finished rotation value (in combination with its respective direction) to the last updated ideal position.

It should be noted that the ideal position is the position determined starting from the movement function, thus the position which, in the absence of vibrational phenomena to be compensated for, would be the position which the stepping motor adopts due to the effect of the commands received from the first and second reference signals. This ideal position is important because it allows an understanding of the extent of compensation to be provided, due to a comparison between the ideal position (that is to say, the compensated position which depends on the vector of the ideal positions) and the current position of the stepping motor.

The method comprises a sampling step, which comprises sampling the ideal position to define a position vector. In particular, the number of ideal positions in the position vector depends on the type of compensation algorithm used.

The method comprises, optionally, determining the position vector starting from a delay vector, obtained by sampling the ideal position updated with a predetermined sampling frequency which depends on the maximum angular speed of the stepping motor. Moreover, the delay vector has a size (number of ideal positions sampled) which depends on the frequency or on a vibration period which is characteristic of the element moved, in particular which depends on mechanical parameters (of mass) of the element moved.

The compensation step comprises a step of calculating a compensated position, on the basis of said position vector.

The fact of determining the positions used to calculate the compensated position using a sampling of positions already calculated makes it possible to perform the compensation with more economical integrated circuits, reducing, to all intents and purposes, the total cost of the controller.

The step of calculating the compensated position allows a position to be derived which takes into account the vibrations. The prior art is silent on this point, since the control adjustment is made on the basis of a comparison between the current position and the ideal position. Thus, it does not resolve the technical problem of the vibrations but only the technical problem deriving from any control errors for which the current position differs from the ideal position. It is therefore particularly advantageous to compare the current position with the compensated position and not with the ideal position.

For this reason, at the end of the sampling step, the processor has available a position vector, having n positions.

The step of calculating the compensated position comprises a step of generating the first control signal based on a comparison between the compensated position and the current position of the motor. The step of calculating the compensated position comprises a step of generating the second control signal based on a comparison between the compensated position and the current position of the motor.

Subsequently, at the end of each compensation step, the current position of the stepping motor adopts the value of the compensated position.

In other words, the stepping motor is physically moved to the compensated position, due to the first and second control signals. Therefore, for the new control cycle, the current position (which corresponds to the actual physical position of the stepping motor over time) has the value of the previous compensated position. Therefore, the compensated position of the n-th control cycle is the current position of the n+1-th control cycle.

According to an embodiment, the compensated position is calculated using the following formula:

$$Pc ( t ) = {\sum }_{i = 1}^{n} Ki * Pi$$

wherein Pᵢ is the i-th position of said plurality of ideal positions and Kᵢ is a correction factor associated with the corresponding ideal i-th position.

Preferably, the compensation step is performed by applying an input shaping algorithm on the first and on the second reference signal.

According to an aspect of the invention, the invention provides a method for controlling a 3D printer. The method for controlling the 3D printer comprises a step of sending control signals to an extruder, for controlling the extrusion of printing material. The method comprises a step of moving a print head, using a stepping motor and one or more motion transmission units. The method comprises a step of controlling a stepping motor, comprising one or more of the steps described in the invention with reference to the method for controlling a stepping motor.

According to an aspect of the invention, the invention provides a controller for controlling a stepping motor. Reference may be made to the controller without distinction also with the term control device.

The controller includes an integrated transduction circuit, programmed to receive a movement function, representing a movement of the motor stepping over time. The transduction circuit is programmed to process the movement function. The transduction circuit is programmed to generate a first reference signal, identifying a finished rotation of the stepping motor, and a second reference signal, identifying the direction of the finished rotation controlled by the first reference signal.

The controller comprises an integrated control circuit, connectable to the stepping motor to receive a first and a second control signal, which instruct it to move the stepping motor.

The controller comprises a compensation module, programmed for modifying the first reference signal and/or the second reference signal in such a way as to reduce the extent of the vibrations due to a movement of the stepping motor. From this modification, the compensation module generates the first and the second control signal, starting from the first reference signal and from the second reference signal, respectively.

It should be noted that the term compensation module indicates a functional and non-structural limitation of the controller and does not limit, therefore, the fact that the compensation module is executed inside the integrated transduction circuit, in the integrated control circuit or in a circuit dedicated to the compensation.

In this regard, it should be noted that the invention aims to protect, inter alia, a controller wherein the compensation module is integrated in the integrated control circuit. According to this embodiment, the integrated control circuit is programmed to receive the first and the second reference signal, process it using the compensation module and derive the first and the second control signals. This embodiment allows greater advantages in terms of compactness, calculation efficiency and overall cost but reduces the modularity of the system.

According to other embodiments, the controller comprises an integrated compensation circuit. The integrated compensation circuit is interposed between the integrated transduction circuit and the integrated control circuit. The compensation module is defined by said integrated compensation circuit. Thus, the integrated compensation circuit is physically connected in a removable fashion to the integrated transduction circuit and to the integrated control circuit. This embodiment, even though it comprises a dedicated circuit which increases the overall costs, has significant advantages in terms of flexibility and modularity of the system.

According to an aspect of the invention, the invention provides a 3D printer. The 3D printer comprises one print head, movable in a printing zone for dispensing printing material.

The 3D printer comprises one extruder, configured for feeding printing material to the print head.

The 3D printer comprises at least one stepping motor, configured for moving the print head in the printing zone.

The 3D printer comprises a transmission unit, configured for transmitting the motion of said at least one stepping motor to the movement head. Preferably, the 3D printer comprises a plurality of actuators, each dedicated to a specific movement or actuation of the print head and/or the extruder.

The 3D printer comprises a controller, configured for controlling said at least one stepping motor. The controller of the 3D printer comprises one or more of the features described above with reference to a controller for controlling a stepping motor.

According to an aspect of the invention, the invention provides a computer program comprising instructions for executing the steps of the method for controlling a stepping motor described in the invention.

### BRIEF DESCRIPTION OF THE DRAWINGS

These and other features will become more apparent from the following description of a preferred embodiment, illustrated by way of non-limiting example in the accompanying drawings, in which:

FIG. 1 schematically illustrates a block diagram of a method for controlling a stepping motor.

FIG. 2 schematically illustrates a block diagram of a detail of a compensation step of the method of FIG. 1;

FIGS. 3A and 3B schematically illustrate a first and a second embodiment, respectively, of a controller for controlling a stepping motor;

FIG. 4 schematically illustrates a 3D printer including a controller according to FIG. 3A or 3B.

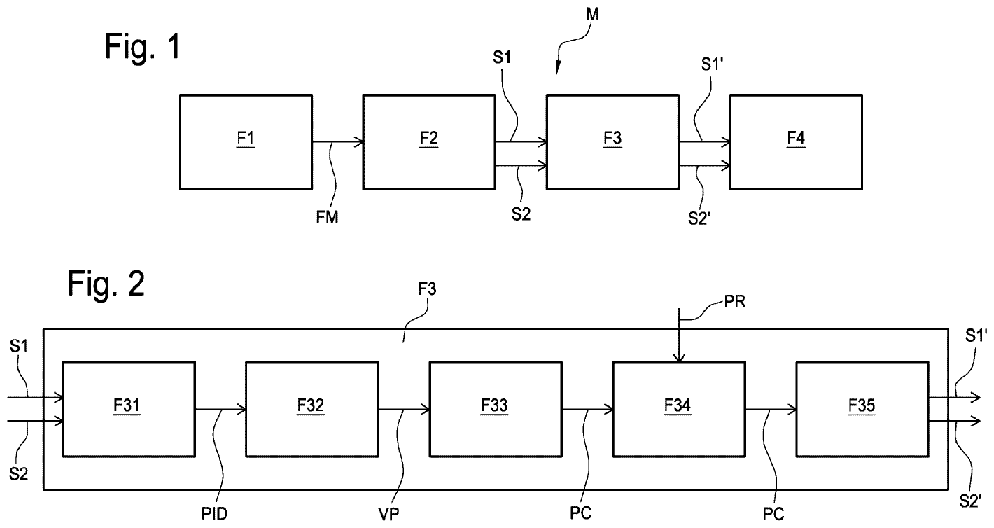

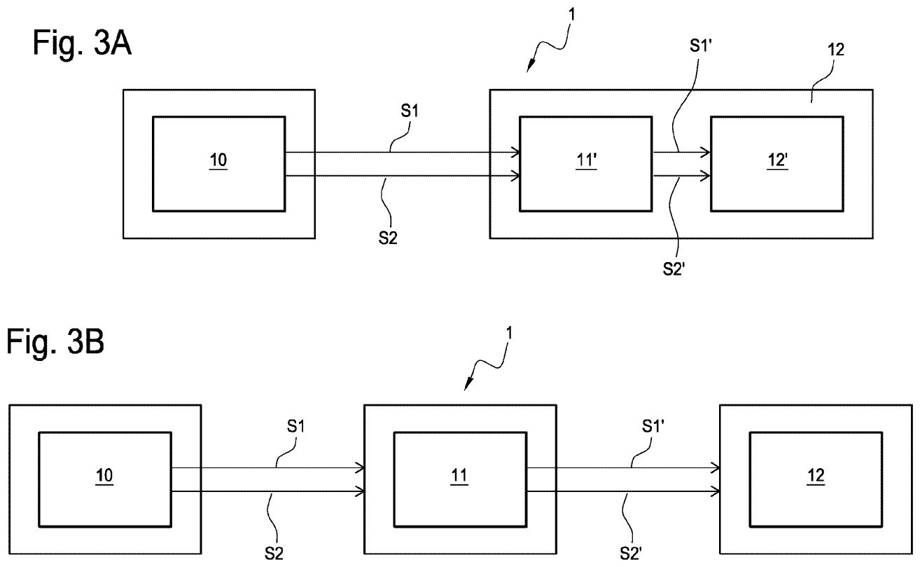

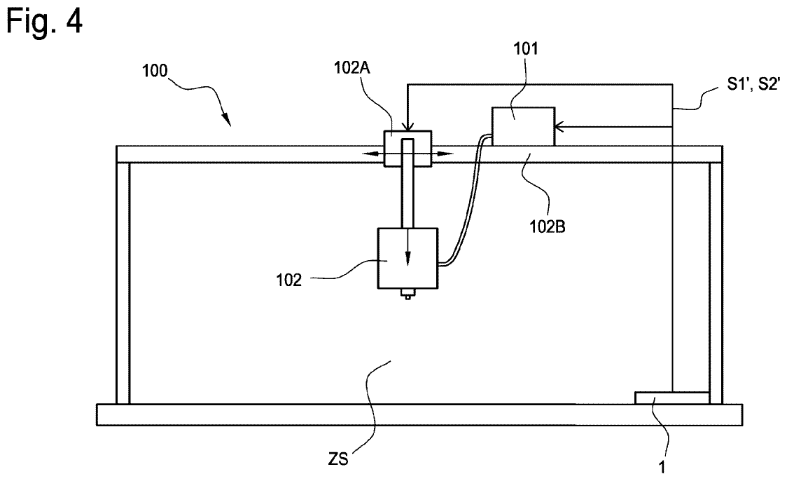

### DETAILED DESCRIPTION OF PREFERRED EMBODIMENTS OF THE INVENTION

With reference to the accompanying drawings, the label M denotes a method for controlling a stepping motor.

The method comprises a step for receiving a movement function (movement profile) F1, representing a position of the stepping motor over time. The receiving step F1 could also be a deriving step, wherein the movement function is derived starting from positioning data.

The method comprises a step for processing the movement function. The method comprises a step F2 of generating a first reference signal S1, identifying a finished rotation of the stepping motor. The first reference signal S1 is commonly known as the STEP signal and indicates the number of steps (or micro-steps which are fractions of the minimum step) which the motor must perform. Each step is associated with an angle of rotation of the motor. In that way, the first reference signal S1 identifies an angle of rotation to be performed.

The method comprises a step of generating a second reference signal S2 identifying the direction of finished rotation controlled by the first reference signal S1. The second reference signal S2 is commonly known as the signal DIR and indicates the direction of rotation of the motor.

Thus, the first and second reference signals S1, S2, in combination, define a unique movement of the motor over time.

The method comprises a step F4 for sending a first control signal S1′ to a control circuit 12 (integrated) of the stepping motor. The method comprises a step F4 for sending a second control signal S2′ to the control circuit 12 of the stepping motor.

Advantageously, the method comprises a compensation step F3. During the compensation step F3, the first reference signal S1 is modified in such a way as to reduce the amount of vibrations due to a movement of the motor, for generating the first control signal S1′. During the compensation step F3, the second reference signal S2 is modified in such a way as to reduce the amount of vibrations due to a movement of the motor, for generating the second control signal S2′.

According to an embodiment, the compensation step F3 comprises a step of accessing a current position value; representing the current position of the stepping motor. In other words, the method comprises always storing in the memory a current position of the motor which may differ from that provided for by the movement function precisely due to the compensation.

The compensation step F3 comprises a step F31 of calculating (updating) an ideal position PI, identifying the ideal current position of the stepping motor. The ideal position PI is determined starting from the first reference signal S1 and from the second reference signal S2. In other words, starting from the first reference signal S1 and from the second reference signal S2 (STEP and DIR signal), the method updates the ideal position which the stepping motor should adopt.

The compensation step F3 comprises a sampling step F32, which comprises sampling the ideal position PI to define a position vector VP.

The determination of the position vector VP, which includes the positions which will then be processed to determine a compensated position PC, may occur in two modes.

According to an initial method, the position vector VP includes all the sampled positions. Thus, the output of the sampling step F32 is the position vector VP which is then used in the compensation algorithm.

According to a particularly advantageous embodiment, the sampling step F32 determines the generation of a delay vector, including a plurality of ideal positions, obtained from the sampling of the ideal position PI, at a certain sampling frequency.

Based on the type of compensation algorithm used, the method comprises a step of selecting one or more ideal positions between said positions of the plurality of ideal positions included in the delay vector. Said two or more ideal positions define the position vector VP. This makes it possible to have a method which is flexible for the implementation of various compensation algorithms, which can select the positions required starting from the delay vector.

It is clarified below that the sampling frequency and the size (number of positions included in the delay vector) of the delay vector depend on the maximum angular speed of the stepping motor and/or on a frequency value or a period value of the vibration which is aimed at compensating and, therefore, on mechanical parameters associated with the element connected to the stepping motor (for example, in the case of the 3D printer, the mechanical and dynamic parameters of the 3D printer). On the other hand, the number of positions included in the position vector VP depends, as indicated above, on the type of compensation algorithm.

The fact of determining the positions used to calculate the compensated position PC using a sampling of positions already calculated makes it possible to perform the compensation with more economical integrated circuits, reducing, to all intents and purposes, the total cost of the controller.

The compensation step F3 comprises a step F33 of calculating a compensated position PC, on the basis of the position vector VP.

The method comprises setting a predetermined sampling frequency value, representing the time between a sampling of the ideal position PI and the next sampling. The predetermined sampling frequency value depends on a maximum speed value of the element connected to the stepping motor (in the case for controlling the 3D printer, the maximum speed of a print head). It should be noted that the method also comprises sampling of the ideal position which does not have, as the first value, the value of the last updated ideal position. Thus, the method comprises starting sampling from the ideal position starting from a sampling start position.

According to an embodiment, the method comprises a step for receiving configuration data, representing one or more of the following features:
Sampling frequency;
Sampling period;
Sampling starting position.

For this reason, at the end of the sampling step F32, the processor has available the position vector VP, having n positions. It should be noted that the delay vector can therefore have n positions, such as the vector positions VP or a number of positions j, greater than n.

The compensation step F3 comprises a step F34 for comparing between the compensated position PC and the current position PR of the motor. The compensation step F3 comprises a step F35 of generating the first control signal S1′ and the second control signal S2′ based on the result of the comparison step F34.

In other words, if the processor detects that the compensated position is different from the current position, it generates the first and the second control signals (which can be defined as modified STEP and modified DIR) for moving the stepping motor from the current position PR to the calculated compensated position PC.

Subsequently, at the end of each compensation step F3, the current position PR of the stepping motor adopts the value of the compensated position PC.

According to an embodiment, the calculation F33 of the compensated position PC is performed using the following formula:

$$Pc ( t ) = {\sum }_{i = 1}^{n} Ki * Pi$$

wherein Pᵢ is the i-th ideal position included in the position vector VP (and possibly selected by the delay vector) and Kᵢ is a correction factor associated with the corresponding ideal i-th position of the position vector VP.

Preferably, the compensation step F3 is performed by applying an input shaping algorithm on the first and on the second reference signal S1, S2. For the purposes of description, reference is made to the content of patent document EP0433375B1, with particular reference to the compensation technique indicated in the patent with the term Input Shaping®.

An example of input shaping necessary for the sufficient description of the compensation process is given below without any intention of limiting itself to that compensation technique, which, in itself, does not in any way constitute an essential element for this invention.

An example of a formula for calculating the compensated position at a certain instant is as follows:

$$Pc ( t ) = {\sum }_{i = 1}^{n} {K}_{i} * P ( t - {t}_{i} ) \qquad ( Eq . 1 )$$

where:
P_{c}(t) compensated position at instant t;
P(t−tᵢ) ideal position at time t−tᵢ
Kᵢ a correction factor
n the number of mediated ideal positions included in the position vector VP.

The time tᵢ is the delay time corresponding to the i-th position of the position vector VP.

By way of example, standard compensation example is given, for which the equation Eq. 1 is calculated using the following values

$$n = 2$$

$${t}_{1} = 0$$

$${t}_{2} = 0.5 {T}_{d}$$

$${K}_{1} = 1 / ( 1 + k )$$

$${K}_{2} = k / ( 1 + k )$$

$$Where :$$

$$Td = \frac{2 π}{ω \sqrt{1 - {ζ}^{2}}}$$

$$k = {e}^{πζ / \sqrt{1 - {ζ}^{2}}}$$

ω=angular frequency of the vibration to be reduced
ζ=damping coefficient.

In this case, the method comprises calculating a delay vector including a number of positions greater than two units. However, the method comprises selecting, between said positions of the delay vector, the position at time 0 and the position with a delay equal to half of the oscillation period.

Only by way of an example, therefore, in this case there could be two vectors of the following type:

$$Delay vector = [ ( 0 , {P}_{0} ) , ( 0.3 {T}_{d} , {P}_{0.3 Td} ) , ( 0.5 {T}_{d} , {P}_{0.5 Td} ) , ( 0.7 {T}_{d} , {P}_{0.7 Td} ) , ( {T}_{d} , {P}_{T d} ) ] ;$$

$$VP = [ ( 0 , {P}_{0} ) , ( 0.5 {T}_{d} , {P}_{0.5 Td} ) ]$$

Therefore, for example, the position vector is determined by selecting the first and the third position of the delay vector.

The formulas described below clearly clarify the algorithm which can be implemented to allow a compensation on the first and on the second reference signals.

According to an aspect of the invention, the invention provides a method for controlling a 3D printer 100. The method for controlling the 3D printer 100 comprises a step of sending control signals to an extruder 101, for controlling the extrusion of printing material. The method comprises a step of moving a print head 102, using a stepping motor 102A and one or more motion transmission units 102B. The method comprises a step of controlling a stepping motor, comprising one or more of the steps described in the invention with reference to the method for controlling a stepping motor.

According to an aspect of the invention, the invention provides a controller 1 for controlling a stepping motor 102A.

The controller 1 includes an integrated transduction circuit 10, programmed to receive a movement function FM, representing a movement of the motor stepping 102A over time. The transduction circuit 10 is programmed to process the movement function FM. The transduction circuit 10 is programmed to generate a first reference signal S1, identifying a finished rotation of the stepping motor 102A, and a second reference signal S2, identifying the direction of the finished rotation controlled by the first reference signal S1.

The controller 10 comprises an integrated control circuit 12, connectable to the stepping motor 102A to receive a first and a second control signal S1′, S2′, which instruct it to move the stepping motor 102A.

The controller 10 comprises a compensation module 11′, programmed for modifying the first reference signal S1 and/or the second reference signal S2 in such a way as to reduce the extent of the vibrations due to a movement of the stepping motor 102A. From this modification, the compensation module 11′ generates the first and the second control signals S1′, S2′, starting from the first reference signal S1 and from the second reference signal S2, respectively.

Reference to the compensation module 11′ means a software module which can be executed on different types of integrated circuits. For this reason, precisely because of this functional definition of the compensation module 11′, the compensation module may be executed inside the integrated transduction circuit 10 (as a software module), inside the integrated control circuit 12 (as a dedicated hardware module) or in a circuit dedicated to the compensation 11 (having a relative calculation power dedicated solely to the execution of the compensation steps).

Thus, according to a first embodiment, the compensation module 11′ is integrated (implemented) in the integrated control circuit 12. According to this embodiment, the integrated control circuit 12 comprises a control module 12′. The integrated control circuit 12 is programmed to receive the first and the second reference signal S1, S2, process it using the compensation module 11′ to derive the first and the second control signals S1′, S2′. The first control signal S1′ and the second control signal S2′ are then processed in the control module 12′ for actually controlling the stepping motor 102A.

In particular, according to this embodiment, the integrated control circuit is designed, from the hardware point of view, to execute the steps of the method according to the invention. This embodiment, whilst being static and less flexible, nevertheless guarantees a reduction in costs and an increased compactness of the control.

According to a second embodiment, the compensation module 11′ is integrated (executed, launched) in the integrated transduction circuit 10. According to this embodiment, the integrated transduction circuit 10 is programmed to directly process the first and the second reference signals S1, S2, for deriving (generating) the first and the second control signals S1′, S2′. This embodiment is more suitable for less flexible systems, in which it is more or less certain that the functions of the controller will not change substantially after its design.

According to a third embodiment, which is particularly flexible and modular, the controller 10 comprises an integrated compensation circuit 11. The integrated compensation circuit 11 is interposed between the integrated transduction circuit 10 (from which it receives the first and the second reference signals S1, S2) and the integrated control circuit 12 (to which the first and the second control signals S1′, S2′ are sent). The compensation module 11′ is defined (executed, launched) by (on) said integrated compensation circuit 11. Thus, the integrated compensation circuit 11 is physically connected in a removable fashion to the integrated transduction circuit 10 and to the integrated control circuit 12.

According to an aspect of the invention, the invention provides a 3D printer 100. The 3D printer comprises one print head 102, movable in a printing zone ZS for dispensing printing material. According to an embodiment, the 3D printer comprises a plurality of print heads, movable in the printing zone ZS for printing from various positions in series or in parallel.

The 3D printer comprises one extruder 101, configured for feeding printing material to the print head 102. According to an embodiment, the 3D printer comprises a plurality of extruders.

The 3D printer comprises at least one stepping motor 102A, configured for moving the print head 102 in the printing zone ZS.

The 3D printer comprises a transmission unit 102B, configured for transmitting the motion of said at least one stepping motor 102A to the print head 102. Preferably, the 3D printer comprises a plurality of actuators, each dedicated to a specific movement or actuation of the print head 102 and/or the extruder 101.

The 3D printer comprises a controller 1, configured for controlling said at least one stepping motor 102A. The controller 1 of the 3D printer 100 comprises one or more of the features described above with reference to a controller 1 for controlling a stepping motor 102A.

According to an aspect of the invention, the invention provides a computer program, comprising instructions for executing the steps of the method M for controlling a stepping motor 102A described in the invention.

1. A method for controlling a stepping motor including the following steps:
receiving a movement function, representing a position of the stepping motor over time;
processing the movement function and generating a first reference signal, identifying a finished rotation of the stepping motor, and a second reference signal, identifying the direction of the finished rotation controlled by the first reference signal;
sending a first and a second control signal to an integrated control circuit of the stepping motor, characterised in that it comprises a compensation step, wherein the first reference signal and the second reference signal are modified in such a way as to reduce the extent of the vibrations due to a movement of the stepping motor, for generating the first and the second control signal, respectively.

2. The method according to claim 1, wherein the compensation step comprises the following steps:
access to a current position value; representing the current position of the stepping motor;
sampling an ideal position to generate a position vector, including a plurality of ideal positions adopted by the stepping motor and determined starting from the first reference signal and from the second reference signal;
calculating a compensated position, on the basis of said position vector;
generating the first and the second control signal, on the basis of a comparison between the compensated position and the current position of the stepping motor.

3. The method according to claim 2, wherein, at the end of each compensation step, the current position of the stepping motor adopts the value of the compensated position calculated.

4. The method according to claim 2, wherein the calculation of the compensated position is carried out using the following formula:
$$P c ( t ) = {\sum }_{i = 1}^{n} K i * P i$$
wherein Pᵢ is the i-th position of said position vector and Kᵢ is a correction factor associated with the corresponding ideal i-th position.

5. The method according to claim 1, wherein the compensation step is performed by applying an input shaping algorithm on the first and on the second reference signal.

6. A method for controlling a 3D printer, comprising the following steps:
sending control signals to an extruder, for controlling it in the extrusion of printing material;
moving a print head, using a stepping motor and one or more motion transmission units;
stepping motor control,
wherein the step of controlling the stepping motor is performed according to claim 1.

7. A controller for controlling a stepping motor including:
an integrated transduction circuit, programmed for:
receiving a movement function, representing a movement of the stepping motor over time;
processing the movement function;
generating a first reference signal, identifying a finished rotation of the stepping motor, and a second reference signal, identifying the direction of the finished rotation controlled by the first reference signal;
an integrated control circuit, connectable to the stepping motor and configured to receive a first and a second control signal, which instruct it to move the stepping motor, wherein the controller comprises a compensation module, programmed for modifying the first reference signal and the second reference signal in such a way as to reduce the extent of the vibrations due to a movement of the stepping motor, for generating the first and the second control signal, starting from the first reference signal and from the second reference signal, respectively.

8. The controller according to claim 7, wherein the compensation module is integrated in the integrated control circuit and wherein the integrated control circuit is programmed to receive the first and the second reference signal, process it in the compensation module to derive the first and the second control signal.

9. The controller according to claim 8, comprising an integrated compensation circuit, interposed between the integrated transduction circuit and the integrated control circuit, and wherein the compensation module is performed in said integrated compensation circuit.

10. A 3D printer comprising:
at least one print head, movable in a printing zone for dispensing printing material;
at least one extruder, configured for feeding printing material to the print head;
at least one stepping motor, configured for moving the print head in the printing zone;
a transmission unit, configured for transmitting the motion of said at least one stepping motor to the movement head;
a controller, configured for controlling said at least one stepping motor according to claim 7.

11. A computer program, comprising instructions for performing the steps of the method according to claim 1.
